(19) United States
(12) Patent Application Publication
(10) Pub. No.: US 2014/0337924 A1
(43) Pub. Date: Nov. 13, 2014

(54) METHODS AND SYSTEMS FOR DYNAMIC LICENSE MANAGEMENT

(71) Applicant: RESEARCH IN MOTION LIMITED, Waterloo (CA)

(72) Inventors: Andrew Christopher SMITH, Mississauga (CA); Lee TROTTER, Hamilton (CA); Marius BOZSITZ, Waterloo (CA); Kafeelurrahman KOTAPALI, Mississauga (CA)

(73) Assignee: RESEARCH IN MOTION LIMITED, Waterloo (CA)

(21) Appl. No.: 13/891,265

(22) Filed: May 10, 2013

(51) Int. Cl. H04L 29/06; G06F 21/45; G06F 21/12

(52) U.S. Cl. CPC H04L 63/10; G06F 21/12; G06F 21/45
USPC 726/4

(57) ABSTRACT

Methods and systems for management of licenses for licensed features activatable on a server. In response to receipt of a request for activation of a requested feature on the server, a license count and a feature usage count are determined. It is determined whether the license count is sufficient to satisfy the request. When the license count is sufficient to cover the request, activation of the requested feature on the server is allowed. Otherwise, the request is refused.

### TECHNICAL FIELD

The present disclosure relates to management of licenses, including management of feature licenses for devices operating on a server or a group of distributed servers and server components.

### BACKGROUND

A licensed feature may be a feature (e.g., application, function and/or service) provided by a vendor for which a customer must purchase a license in order to access. Where a corporation has a corporate server managing a plurality of employee devices, licenses or license tokens for accessing features (including cloud-based features) may be distributed to individual employee devices through the corporate server. In some cases, an employee device may hold onto a license even when the licensed feature is not being used by the device, thus preventing other employee devices from using the licensed feature.

It is often challenging for a corporate server to track the licenses being held and licensed features being used, and it is often difficult for a corporate server to ensure that purchased licenses are being efficiently used to access licensed features.

### BRIEF DESCRIPTION OF THE DRAWINGS

Reference will now be made to the drawings, which show by way of example embodiments of the present disclosure, and in which:

FIG. 1 is a block diagram illustrating an example communication system;

FIG. 2 is a block diagram illustrating an example wireless device;

FIG. 3 is a block diagram illustrating an example license management system;

FIG. 4 is a table illustrating some example licensed features and corresponding licenses; and

FIG. 5 is a flowchart illustrating an example method of managing licenses, from the viewpoint of a device management server.

It will be noted that throughout the appended drawings, like features are identified by like reference numerals.

### DETAILED DESCRIPTION OF EXAMPLE EMBODIMENTS

In some example aspects, the present disclosure provides a method for management of licenses for licensed features activatable on a server, in which the method may include: in response to receipt of a request for activation of a requested feature on the server, determining a license count and a feature usage count, the license count being indicative of a count of all licenses activated on the server, and the feature usage count being indicative of all licensed features activated on the server; determining whether the license count is sufficient to satisfy the request; when the license count is sufficient to cover the request, allowing activation of the requested feature on the server; and otherwise, refusing the request.

In some example aspects, the present disclosure provides a server for management of licenses for licensed features activatable on the server, in which the server may include a processor configured to execute computer-readable instructions executable to cause the server to: in response to receipt of a request for activation of a requested feature on the server, determine a license count and a feature usage count, the license count being indicative of a count of all licenses activated on the server, and the feature usage count being indicative of all licensed features activated on the server; determine whether the license count is sufficient to satisfy the request; when the license count is sufficient to cover the request, allow activation of the requested feature on the server; and otherwise, refuse the request.

In some example aspects, the present disclosure provides a computer program product tangibly embodying computer-readable instructions thereon, in which the instructions may be executable to cause a processor to: in response to receipt of a request for activation of a requested feature on a server, determine a license count and a feature usage count, the license count being indicative of a count of all licenses activated on the server, and the feature usage count being indicative of all licensed features activated on the server; determine whether the license count is sufficient to satisfy the request; when the license count is sufficient to cover the request, allow activation of the requested feature on the server; and otherwise, refuse the request.

Other aspects and features of the example embodiments will be apparent in view of the following detailed description.

Reference will now be made to the accompanying drawings which show example embodiments of the present disclosure. For simplicity and clarity of illustration, reference numerals may be repeated among the figures to indicate corresponding or analogous elements. Numerous details are set forth to provide an understanding of the example embodiments described herein. The example embodiments may be practiced without some of these details. In other instances, suitable variations to the disclosed methods, procedures, and components have not been described in detail to avoid obscuring the example embodiments described, but are within the scope of the present disclosure. The description is not to be considered as limited to the scope of the example embodiments described herein.

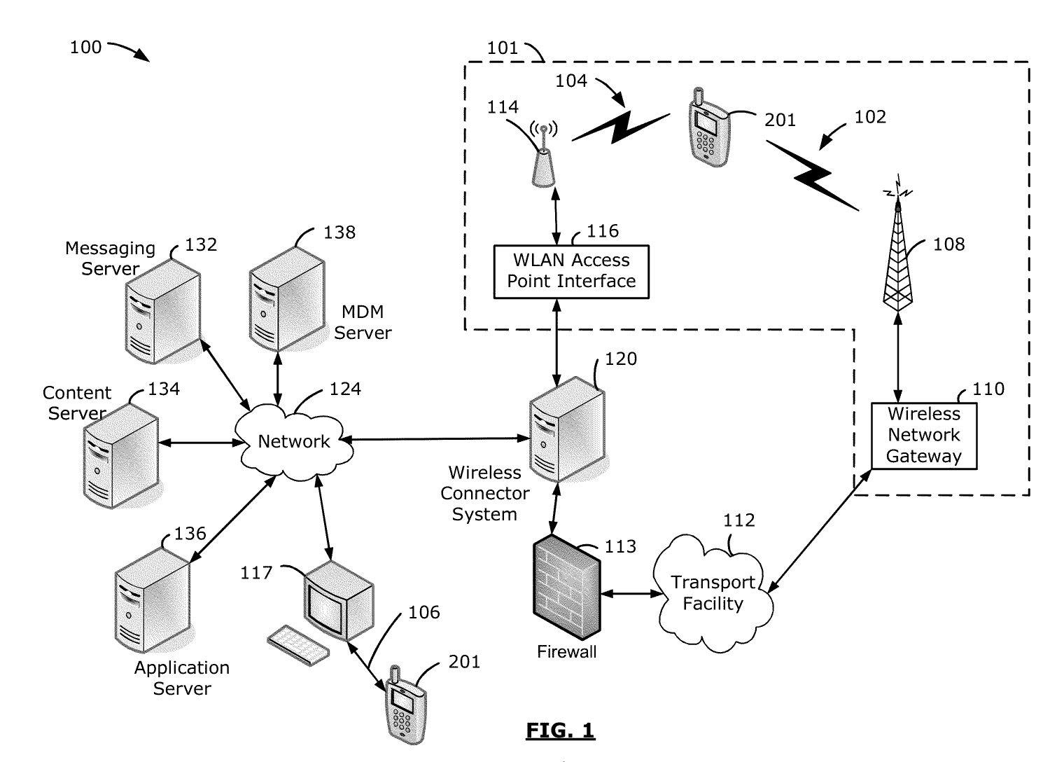

FIG. 1 shows in block diagram form an example communication system 100 in which example embodiments of the present disclosure can be implemented. The communication system 100 may comprise one or more wireless communication devices (referred to hereinafter as “wireless devices” for convenience) 201 which may be connected to the remainder of system 100 in any of several different ways. Accordingly, several instances of the wireless device 201 are depicted in FIG. 1 employing different example ways of connecting to system 100. The wireless device 201 will be described in further detail below. The wireless device 201 may be connected to a wireless communication network 101 which may comprise one or more of a Wireless Wide Area Network (WWAN) 102, a Wireless Local Area Network (WLAN) 104, and/or other suitable network arrangements. In some examples, the wireless device 201 may be configured to communicate over both the WWAN 102 and WLAN 104, and may be configured to permit roaming between these networks 102, 104. In some examples, the wireless network 101 may comprise multiple WWANs 102 and/or WLANs 104.

The WWAN 102 may be implemented as any suitable wireless access network technology. By way of example, but not limitation, the WWAN 102 may be implemented as a wireless network that may include one or more transceiver base stations 108 (one of is shown in FIG. 1 as an example). Each of the base station(s) 108 may provide wireless Radio Frequency (RF) coverage to a corresponding area or cell. The WWAN 102 may be operated by a wireless network service provider that may provide a subscription package to a user of the wireless device 201. In some examples, the WWAN 102 may conform to one or more of the following wireless network types: Mobitex Radio Network, DataTAC, Global System for Mobile Communication (GSM), General Packet Radio System (GPRS), Time Division Multiple Access (TDMA), Code Division Multiple Access (CDMA), Cellular Digital Packet Data (CDPD), integrated Digital Enhanced Network (iDEN), Evolution-Data Optimized (Ev-DO) CDMA2000, Enhanced Data rates for GSM Evolution (EDGE), Universal Mobile Telecommunication Systems (UMTS), High-Speed Downlink Packet Access (HSDPA), IEEE 802.16e (which may also be referred to as Worldwide Interoperability for Microwave Access or “WiMAX”), IEEE 802.16m (which may also be referred to as Wireless Metropolitan Area Networks or “WMAN”), 3GPP Long Term Evolution (LTE), LTE Advanced, IEEE 802.20 (which may also be referred to as Mobile Broadband Wireless Access or “MBWA”) or other suitable network types. Although WWAN 102 may be described as a “Wide-Area” network, that term is intended herein to incorporate other similar technologies for providing coordinated service wirelessly over an area larger than that covered by typical WLANs.

The WWAN 102 may further comprise one or more wireless network gateways 110 which may connect the wireless device 201 to one or more transport facilities 112, and through the transport facility(ies) 112 to a wireless connector system 120. The transport facility(ies) 112 may include one or more private networks or lines, the public Internet, a virtual private network, or any other suitable network. The wireless connector system 120 may be operated, for example, by an organization or enterprise such as a corporation, university, or governmental department, and may allow access to a network 124 such as a private network (also known as an internal or enterprise network) and any shared resources of the private network, and/or the Internet. In some examples, the wireless connector system 120 may be operated by a mobile network service provider.

The wireless network gateway 110 may provide an interface between the wireless connector system 120 and the WWAN 102, which may facilitate communication between one or more wireless devices 201 and other devices (not shown) connected, directly or indirectly, to the WWAN 102. Accordingly, communications sent via the wireless device 201 may be transported via the WWAN 102 and the wireless network gateway 110 through transport facility(ies) 112 to the wireless connector system 120. Communications sent from the wireless connector system 120 may be received by the wireless network gateway 110 and transported via the WWAN 102 to the wireless device 201.

The WLAN 104 may comprise a wireless network which, in some embodiments, may conform to IEEE 802.11x standards (sometimes referred to as Wi-Fi) such as, for example, the IEEE 802.11a, 802.11b and/or 802.11g standard. Other communication protocols may be used for the WLAN 104 in other embodiments such as, for example, IEEE 802.11n, IEEE 802.16e, IEEE 802.16m or IEEE 802.20. The WLAN 104 may include one or more wireless RF access points 114 (one of which is shown in FIG. 1) that may collectively provide a WLAN coverage area.

The WLAN 104 may be a personal network of the user, an enterprise network, or a hotspot offered by an Internet service provider (ISP), a wireless network service provider, or a property owner in a public or semi-public area, for example. The access point(s) 114 may be connected to an access point interface 116 which may connect to the wireless connector system 120 directly (for example, if the access point(s) 114 is part of an enterprise WLAN 104 in which the wireless connector system 120 resides), or indirectly (e.g., via the transport facility(ies) 112), such as if the access point(s) 114 is a personal Wi-Fi network or Wi-Fi hotspot (in which case a mechanism for securely connecting to the wireless connector system 120, such as a virtual private network (VPN), may be required). The access point interface 116 may provide translation and routing services between the access point(s) 114 and the wireless connector system 120 to facilitate communication, directly or indirectly, with the wireless connector system 120.

The wireless connector system 120 may be implemented as one or more servers (one is shown in FIG. 1), and may be located behind a firewall 113. The wireless connector system 120 may manage communications, such as email messages, to and from a set of managed wireless devices 201. The wireless connector system 120 may provide administrative control and management capabilities over users and wireless devices 201 which may connect to the wireless connector system 120.

The wireless connector system 120 may allow the wireless device 201 to access the network 124 (e.g., a corporate network) and connected resources and services such as one or more messaging servers 132, one or more content servers 134 for providing content such as Internet content or content from an organization's internal servers to the mobile devices 201 in the wireless network 101, one or more application servers 136 for implementing server-based applications, one or more mobile device management (MDM) server 138 for providing wireless services (e.g., corporate wireless services, enterprise services and/or other device management services), and the like.

In some examples, the MDM server 138 may be a private corporate server, and may also be referred to as an enterprise server. The MDM server 138 may provide services to and manage a plurality of wireless devices 201 activated to operate on the MDM server 138. As described further below, the MDM server 138 may manage feature licenses used by managed wireless devices 201 to access one or more licensed features provided by a vendor. In some examples, such licensed features may include applications, functions and/or services provided by the wireless connector system 120 via the MDM server 138, by the MDM server 138 and/or by a third-party service provider (not shown). Although shown as a single server, the MDM server 138 may in fact include two or more servers. For example, the devices 201 may be managed by a group of distributed servers acting in the role of the MDM server 138.

The wireless connector system 120 may provide a secure exchange of data (e.g., communications and other messages such as email messages, personal information manager (PIM) data, and IM data) with the wireless device 201. In some embodiments, communications between the wireless connector system 120 and the wireless device 201 may be encrypted. In some embodiments, communications may be encrypted using any suitable encryption method, such as a symmetric encryption key implemented using Advanced Encryption Standard (AES) or Triple Data Encryption Standard (Triple DES) encryption. Private encryption keys may be generated in a secure, two-way authenticated environment and may be used for both encryption and decryption of data.

The wireless network gateway 110 may be adapted to send data packets received from the wireless device 201 over the WWAN 102 to the wireless connector system 120. The wireless connector system 120 may then send the data packets to the appropriate connection point such as a messaging server 132, content server 134, application server 136 or MDM server 138. Conversely, the wireless connector system 120 may send data packets received, for example, from the messaging server 132, content server 134, application server 136 or MDM server 138 to the wireless network gateway 110 which may then transmit the data packets to the destination wireless device 201. The access point interface 116 of the WLAN 104 may provide similar sending functions between the wireless device 201, the wireless connector system 120 and a network connection point such as a messaging server 132, content server 134, application server 136 or MDM server 138.

The network 124 may comprise one or more networks, such as a private local area network, private corporate network, metropolitan area network, wide area network, the public Internet or combinations thereof and may include virtual networks constructed using any of these, alone, or in combination.

One or more computers 117 (one is shown in FIG. 1), such as a desktop or, notebook computer, may also be connected to the network 124, such as by a wired or wireless communication link. A wireless device 201 may connect to the wireless connector system 120 using a computer 117 via the network 124 rather than using the WWAN 102 or WLAN 104. A communication link 106 may be provided for exchanging information between the wireless device 201 and a computer 117 connected to the wireless connector system 120. The link 106 may comprise one or both of a physical interface for a wired communication link and a wireless communication interface (e.g., a short-range wireless communication interface, such as a Bluetooth® interface) for a wireless communication link.

The communication system 100 may be implemented, at least in part, as a cloud-based solution in which computer(s) 117 and wireless device(s) 201 may share access to the network resources, e.g. messaging server 132, content server 134, application server 136, MOM server 138, software and other data and information. In a cloud implementation, the network 124 may be implemented using the Internet rather than a private network, although the network 124 may be viewed as a private cloud rather than a public cloud in the form of public Internet based services.

Access to cloud-based applications (referred to hereinafter as “cloud applications”), such as messaging applications, may be through, for example, a web browser or thin client on the computer 117 and/or wireless device 201. The majority of the processing logic and data of cloud applications may be stored on the shared resources (e.g., servers) which may be at a remote location. Cloud applications may allow access from nearly any computer 117 and/or wireless device 201 having access to the network 124 (e.g., the Internet). Access to cloud applications may require the use of a license. Cloud applications may facilitate a converged infrastructure and shared services, which in turn may facilitate deployment of applications with easier manageability and less maintenance.

The above-described communication system is provided for the purpose of illustration only, and the above-described communication system comprises an example possible communication network configuration out of a multitude of possible configurations for use with the wireless device 201. The teachings of the present disclosure may be employed in connection with any other type of network and associated devices that are effective in implementing or facilitating wireless communication. Variations of the communication system are intended to fall within the scope of the present disclosure. For example, while the wireless device 201 has been described as communicating with a wireless connector system 120 in the above-described embodiments, the wireless connector system 120 may be omitted in other embodiments. Some or all of the functions of the wireless connector system 120 may be implemented by various communication endpoints, or possibly a cloud-based resource such as a cloud-based server.

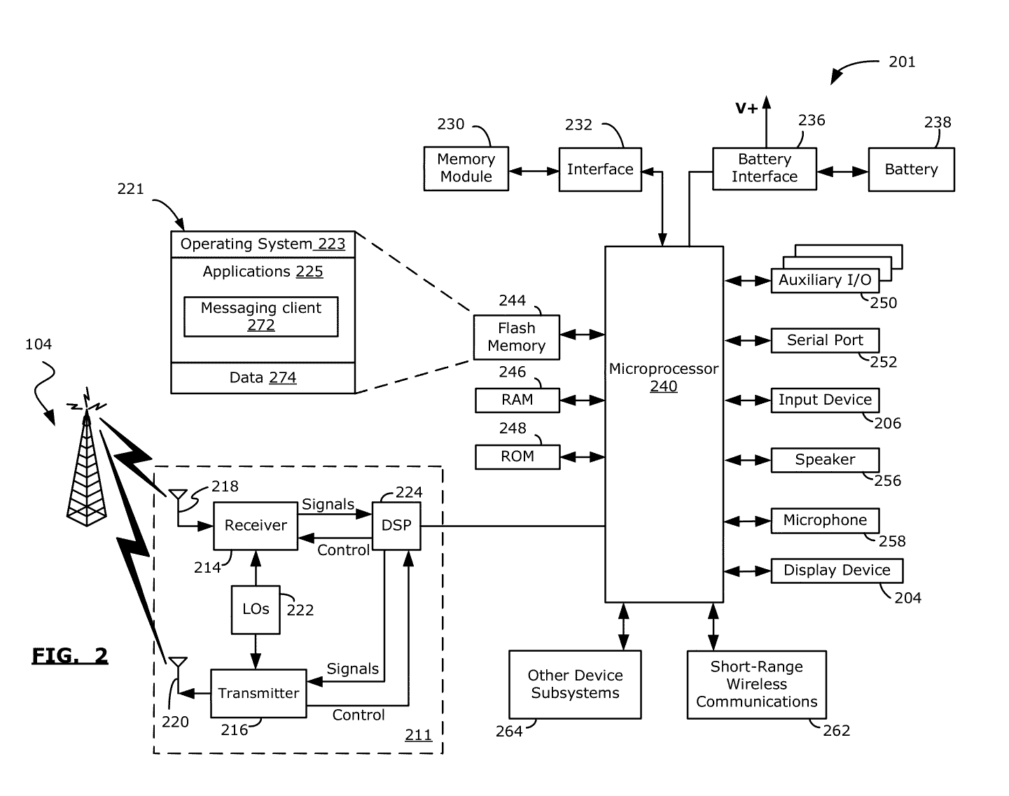

FIG. 2 illustrates an example wireless device 201 which may be suitable for implementation of example embodiments described in the present disclosure. The wireless device 201 may be a two-way communication device having data and voice communication capabilities, and the capability to communicate with other computer systems, for example, via the Internet. Depending on the functionality provided by the wireless device 201, in various embodiments the device 201 may be a multiple-mode communication device configured for both data and voice communication. The wireless device 201 may be referred to as a mobile communication device, a mobile device, a smartphone, a personal digital assistant, a cellular telephone, a tablet device or a palm device, for example.

The wireless device 201 may include a rigid case (not shown) housing the components of the device 201. The internal components of the device 201 may be constructed on a printed circuit board (not shown). The mobile device 201 may include a controller comprising at least one processor 240 (such as a microprocessor) which may control the overall operation of the device 201. The processor 240 may interact with one or more device subsystems such as a wireless communication subsystem 211 for exchanging RF signals with the wireless network 101 to perform communication functions. The processor 240 may interact with one or more additional device subsystems including a display 204 such as a liquid crystal display (LCD); one or more input devices 206 such as a touch-sensitive device (e.g., a touch-sensitive display or touch-sensitive overlay), a keyboard and/or control buttons; one or more memories such as a flash memory 244, a random access memory (RAM) 246 and/or a read only memory (ROM) 248; an auxiliary input/output (I/O) subsystem 250; a data port 252 such as serial data port (e.g., Universal Serial Bus (USB) data port); a speaker 256; a microphone 258; a short-range communication subsystem 262; and other device subsystems generally designated as 264.

In some examples, the input device 206 and the display 240 may be embodied in the same subsystem, such as a touch-sensitive display (also referred to as a touchscreen display). The input device 206 may include a touch-sensitive display, in addition to, or instead of, a keyboard. The touch-sensitive display may be constructed using a touch-sensitive input surface connected to an electronic controller and which may overlay the display 204. The touch-sensitive overlay and the electronic controller may provide a touch-sensitive input device and the processor 240 may interact with the touch-sensitive overlay via the electronic controller.

The communication subsystem 211 may include a receiver 214, a transmitter 216, and associated components, such as one or more antenna elements 218, 220, one or more local oscillators (LOs) 222, and a processing module such as a digital signal processor (DSP) 224. The antenna element(s) 218, 220 may be embedded or internal to the wireless device 201 and a single antenna may be shared by both receiver and transmitter. The particular design of the wireless communication subsystem 211 may depend on the wireless network 101 in which the wireless device 201 is intended to operate.

The wireless device 201 may communicate (e.g., via the antenna element(s) 218, 220) with the wireless network 101 in any suitable manner, such as with the transceiver base station 108 within its geographic coverage area, as described above. The wireless device 201 may send and receive communication signals over the wireless network 101, such as after the required network registration or activation procedures have been completed. Signals received by the antenna 218 through the wireless network 101 may be input to the receiver 214, which may perform suitable receiver functions such as signal amplification, frequency down conversion, filtering, and channel selection, among others, as well as analog-to-digital (A/D) conversion. A/D conversion of a received signal may allow more complex communication functions such as demodulation and decoding to be performed in the DSP 224. In a similar manner, signals to be transmitted may be processed, including modulation and encoding, for example, by the DSP 224. These DSP-processed signals may be input to the transmitter 216 for digital-to-analog (D/A) conversion, frequency up conversion, filtering, amplification, and transmission to the wireless network 101 via the antenna 220. The DSP 224 may not only process communication signals, but may also provide for receiver and transmitter control. For example, the gains applied to communication signals in the receiver 214 and the transmitter 216 may be adaptively controlled through automatic gain control algorithms implemented in the DSP 224.

The processor 240 may operate under stored program control and may execute instructions 221 (which may be referred to as software or modules) stored in memory such as persistent memory, for example, in the flash memory 244. As illustrated in FIG. 2, such instructions 221 may implement an operating system 223 and software applications 225. The software applications 225 may include a messaging client 272, which may be part of a personal information manager (PIM). Persistent data 274, including user data, may also be stored in the flash memory 244.

The instructions 221 or parts thereof may be temporarily loaded into volatile memory such as the RAM 246. The RAM 246 may be used for storing runtime data variables and other types of data or information. Although specific functions are described for various types of memory, this is provided for example only, and a different assignment of functions to types of memory may be used.

In some example embodiments, the wireless device 201 may include a removable memory card 230 (e.g., comprising flash memory) and a memory card interface 232. Network access may be associated with a subscriber or user of the wireless device 201 via the memory card 230, which may be a Subscriber Identity Module (SIM) card for use in a GSM network or other type of memory card for use in the relevant wireless network type. The memory card 230 may be inserted in or connected to the memory card interface 232 of the wireless device 201 in order to operate in conjunction with the wireless network 101.

The wireless device 201 may include a battery 238 as a power source, which may comprise one or more rechargeable batteries that may be charged, for example, through charging circuitry coupled to a battery interface such as the serial data port 252. The battery 238 may provide electrical power to at least some of the electrical circuitry in the wireless device 201, and the battery interface 236 may provide a mechanical and electrical connection for the battery 238. The battery interface 236 may be coupled to a regulator (not shown) which may provide power V+ to the circuitry of the wireless device 201.

The short-range communication subsystem 262 may be an optional component of the wireless device 201, which may provide for communication between the wireless device 201 and different systems or devices, which need not necessarily be similar devices. For example, the subsystem 262 may include an infrared device and associated circuits and components, or a wireless bus protocol compliant communication mechanism such as a Bluetooth® communication module to provide for communication with similarly-enabled systems and devices.

The wireless device 201 may provide at least two modes of communication: a data communication mode and a voice communication mode. In the data communication mode, a received data signal such as a text message, a message, or web page download may be processed by the communication subsystem 211 and input to the processor 240 for further processing. For example, a downloaded web page may be further processed by a browser application or a message may be processed by the messaging client 272 and output to the display 204. A user of the wireless device 201 may also compose data items, such as messages, for example, using the input device 206 in conjunction with the display 204. These composed items may be transmitted through the communication subsystem 211 over the wireless network 101.

In the voice communication mode, the wireless device 201 may provide telephony functions and may operate as a typical cellular phone. The overall operation may be similar, except that the received signals may be output to the speaker 256 and signals for transmission may be generated by a transducer such as the microphone 258. The telephony functions may be provided by a combination of software/firmware (e.g., a voice communication module) and hardware (e.g., the microphone 258, the speaker 256 and input device 206). Alternative voice or audio I/O subsystems, such as a voice message recording subsystem, may also be implemented on the wireless device 201. Although voice or audio signal output may be accomplished primarily through the speaker 256, the display 204 may also be used to provide output, such as an indication of the identity of a calling party, duration of a voice call, or other voice call related information.

The construction of a computer 117 may be generally similar to a wireless device 201 with differences relating primarily to size and form factor, as well as the capabilities of the electronic components (which are typically more powerful and larger than in a mobile device 201 due to fewer design constraints). A computer 117 may be non-portable (e.g., in the case of a desktop computer) and may have physical wired connections to external resources, such as a wall socket for power. A computer 117 may have greater memory, power and processing resources, compared to a wireless device 201. Input and/or output devices for a computer 117 may be larger than for a wireless device 201, which may result in user interfaces designed for use on a computer 117 being different from those designed for use on a wireless device 201. In some examples, software and user interfaces designed for use on a computer 117 may be inappropriate or unsuitable for use on a wireless device 201, and vice versa. The computer 117 may be enabled for wired or wireless communications, as described above. The construction of computers 117 is not the focus of the present disclosure and will not be described further herein.

The term “electronic device” may be used to refer to either a wireless device 201 or a computer 117, unless stated otherwise.

The wireless device 201 may execute computer executable programmed instructions for directing the wireless device 201 to implement various applications and carry out various functions. The programmed instructions may be embodied in the instructions 221 resident in the memory (e.g., flash memory 244) of the wireless device 201. The programmed instructions may also be tangibly embodied on a computer readable medium (such as a DVD, CD, external hard drive, floppy disk or other storage media) which may be used for transporting the programmed instructions to the wireless device 201. Alternatively, the programmed instructions may be embedded in a computer-readable, signal-bearing medium that may be uploaded to the wireless network 101, such as by a vendor or supplier of the programmed instructions, and this signal-bearing medium may be downloaded to the wireless device 201 from, for example, the wireless network 101 by end users.

A user may interact with the wireless device 201 using a graphical user interface (GUI) that may be displayed on the display 204. The GUI may provide a display format enabling the user to choose commands, execute application programs, manage computer files, and perform other functions by selecting pictorial representations (e.g., icons), or selecting items from a menu through the use of the input device 206. The GUI may be used to convey information and/or receive commands from the user and may include a variety of objects and/or controls, such as icons, toolbars, drop-down menus, pop-up menus, text, dialog boxes, and buttons, among others. A user may interact with the GUI presented on the display 204 using the input device 206 to position a pointer or cursor over an object (also referred to as “pointing” at the object) and by selecting the object (also referred to as “clicking” or “highlighting” the object) using the input device 206. This may be referred to as a point-and-click or selection operation.

In some examples, the instructions 221 on the device 201 may include definition of logical perimeters, which may be used to logically separate resources (including, for example, data, applications, functions and/or other information) on the device. Perimeters may be used to define sets of information to which different device management policies (e.g., privacy or security policies) may apply. Resources that are part of one perimeter may be inaccessible or have limited access by resources of another perimeter, unless specifically denoted as being a shared resource.

In some instances, particular resources may be shared among multiple perimeters. For example, a network resource belonging to a first perimeter may be accessible to application(s) belonging to other perimeters. The instructions 221 may include policies for cross-perimeter access that specify rules for individual perimeters, applications, network resources, or any suitable combination.

An administrator of a perimeter may determine which resources of the perimeter can be accessed by other perimeters. For example, a personal perimeter may be managed by the user of the device 201, and a corporate (or enterprise) perimeter can be managed by a corporate administrator (e.g., an IT administrator of the company). Personal applications belonging to the personal perimeter may use network resources belonging to the personal perimeter. The user may have the ability to set whether the personal applications can use a corporate resource, such as a corporate network. For example, due to privacy concerns, a user may not want his or her web browsing information to traverse a corporate network.

In some examples, a corporate administrator may have the ability to set rules on what perimeters (at a macro level) or what applications (at a micro level) can use corporate resources, such as the corporate networks. For example, due to security concerns, a corporate administrator may not want a user-installed application (which may be malware or otherwise) to be able to access corporate network resources. But the administrator may trust certain applications (e.g., applications provided by a particular software provider, or applications having certain security features) and allow those applications to access the corporate network.

Implementation of perimeters may enable a single device 201 to be concurrently used for both personal and work purposes, while keeping personal and work traffic separate. Such use can be provided in a convenient manner that requires little or no user intervention after the initial setup. For example, a user may use the device 201 to access the Internet through non-corporate networks for personal use without being subject to restrictions imposed by their employer, and without having their traffic subject to being monitored or scrutinized by their employer. The user may also use the same device 201 to access the Internet or other network resources through corporate networks for work purposes. The device 201 may be configured to allow corporate control over the work traffic, and the user may be given control over whether personal traffic is allowed to flow on corporate networks.

The use of perimeters may allow a user to use a personal device 201 in a corporate environment and vice versa, by partitioning the user's personal information and personal resources in a personal perimeter, separate from those of the corporation (which may be partitioned in a corporate perimeter). A personal device 201 (that is, a device 201 owned and maintained by a user personally) that is used in the corporate environment may be referred to as an individual liable device. At least the resources within a corporate perimeter defined on an individual liable device may be under the control of corporate administrators. A corporate device 201 (that is, a device 201 owned and maintained by a corporation) may be referred to as a corporate liable device. A corporate liable device may be generally under the control of corporate administrator, except for resources within a user's personal perimeter defined on the device.

In high security environments (e.g., government or financial institutions), certain security features may be implemented on the device 201 to provide the corporation with a higher level of control over the device 201. For example, a government institution may require creation of a log recording all communications through devices 201 used by employees, and may also require the ability to remotely erase all data on devices 201 used by employees, regardless of whether such communications and data are stored or generated within a personal or a corporate perimeter. A device 201 having such a high level of security may be referred to as a secure or restricted device. A device 201 may be converted from a lower security level (e.g., an individual liable device or a corporate liable device) to a higher security level (e.g., a secure device) by implementing security features on the device 201. Such a conversion may be possible by requesting a managing server (e.g., the MDM server 138 belonging to the corporation) to activate security features for the device 201, without requiring hardware changes to the device 201. While it may be possible to convert a device 201 from a higher security level to a lower security level (e.g., by removing security features from the device 201), it may not be desirable to allow such a conversion, for security reasons.

The wireless device 201 may be activated to operate on and be managed by the MDM server 138. The device 201 may be entitled to implement certain features, such as certain applications (e.g., cloud applications) and/or functions (e.g., security features). Such features may be provided to the device 201 via the MDM server 138, through the network 124. Some of these features may be licensed features. Different features may licensed by different license types. For example, a secure license may be required to activate a secure device on the MDM server 138, while a basic license or a standard license may be required to activate an individual liable device on the MDM server 138. The license may be managed by the MDM server 138 on behalf of the device 201, as described further below.

In some examples, a device 201 may be a first-party device that is designed to operate on the MDM server 138. A first-party device may be provided by the same provider as that of the MDM server 138. A first-party device may be considered to be native to the MDM server 138. A third-party device may be provided by a different provider than that of the MDM server 138 and may not be designed to operate specifically on the MDM server 138. A third-party device may be considered to be not native to the MDM server 138. In some examples, while first-party devices may operate on the MDM server 138 by default, it may be necessary to have a license for a third-party device in order for the third-party device to operate on the MDM server 138. Thus, the ability for the third-party device to operate on the MDM server 138 may be a licensed feature.

Thus, different licenses may be required for activation of different features on the MDM server 138. A device 201 may require a license in order to operate on the MDM server 138. The license required may depend on the desired device type (e.g., individual liable, corporate liable, third-party or secure device). Thus, operation of a given type of device 201 on the MDM server 138 may be a licensed feature. Other licensed features may include features that do not relate to devices 201, such as administrative features. In some examples, a given licensed feature may require a plurality of licenses in order to be activated. Conversely, a given license may allow for activation of a plurality of licensed features. In addition to licensed features, other features may be activated without requiring a license.

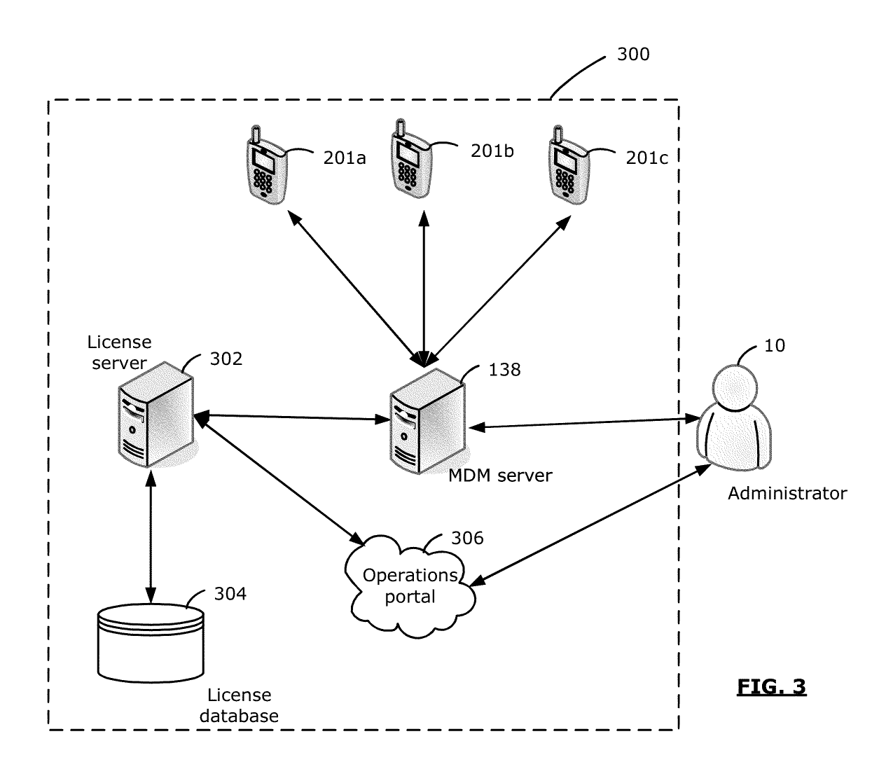

FIG. 3 is a schematic diagram of an example system 300 for managing licenses. The system 300 may operate within and be part of the system 100 of FIG. 1, however, for simplicity, the system 300 is shown isolated from the system 100.

The MDM server 138 may manage operations of a plurality of devices 201 (individually referred to as 201a, 201b, 201c), which may belong to different operational domains. In the present disclosure, a domain may be defined by a characteristic of the device 201. For example, a device 201a running a basic or older generation operating system may belong to domain A, a device 201b running a standard or current generation operation system may belong to domain B, and a device 201c running a third-party operation system (that is, an operating system that is not native to the MDM server 138) may belong to domain C. Domains may be defined in other ways including, for example, by type or generation of the device 201 or by geographical location of the device 201. The MDM server 138 may provide services, including management of licenses, across different domains.

An administrator 10 (e.g., a corporate IT administrator) may manage one or more devices 201 via the MDM server 138, for example. The MDM server 138 may store in its memory information related to managing licenses and feature usage on the managed devices 201. For example, the MDM server 138 may store a license count indicating the total number of licenses held and/or a feature usage count indicating the total number of features activated on the MDM server 138. The license count may be broken down by license type and similarly the feature usage count may be broken down by specific feature.

In other examples, the MDM server 138 may not store the feature usage count, but may determine this information through queries to an external server or an external database, such as the license server 302 or the license database 304, described below, or another database. For example, a database may store a record of each device 201 operating on the MDM server 138 and the record may include an indication (e.g., a flag or attribute value) of the type or mode of the device (e.g., individual liable or corporate liable). Such information may be stored in a database for purposes other than tracking license usage, but may be leveraged by the MDM server 138 for the purpose of tracking usage of license features. The MDM server 138 may query the database and determine the number of devices 201 of each type, thus determining the feature usage count.

The system 300 may include a license server 302. The license server 302 may communicate with an internal or external license database 304. The administrator 10 may carry out transactions with the license server 302 using an operations portal 306. The operations portal 306 may be provided as a secure web-based portal, which may be accessible via the network 124, for example. In some examples, the license server 302 may be cloud-based and one or more components may be behind a firewall.

The license server 302 may provide services for management of licenses. Although shown as a single server, the license server 302 may include two or more servers. The license server 302 may be part of a larger system (e.g., part of a larger customer licensing system (CLS) including a license generator and a license hub for accessing the license server 302), however in the interest of simplicity, only the license server 302 will be described. Examples of services provided by the license server 302 may include, for example: generating new licenses, generating license keys, providing status of current license entitlement, and providing license numbers. The license server 302 may communicate with the license database 304 as necessary in order to provide such services. The license server 302 may manage license data according to separate customer accounts. The MDM server 138 of a given customer (e.g., a given corporation or institution) may securely communicate with the license server 302 to access information about the licenses held by that customer.

The license database 304 may store data indicating the license entitlements associated with individual customer accounts. Entitlement for a particular license on a customer account may indicate that the particular customer holds that license and is entitled to use the feature(s) licensed by that license. The entitlement data associated with a customer account may indicate the total number of each type of license held by the customer, for example, and may include identification of the specific licenses (e.g., specific license number) held. In some examples, the license database 304 may include other information relating to licenses such as purchase costs, license version, expiration dates, overdraft allowance and/or conditions for maintaining a license.

The following pseudo code illustrates and example of the entitlement information stored in the license database 304:

BasicLicense “amount=10; expiry=Jan. 1, 2015; version=2.1; overdraft=0”

The administrator 10 of a customer (e.g., a corporation or institution) may purchase device licenses via the operations portal 306. The purchase may be a bulk purchase of licenses, which may include a combination of different license types, or may be a purchase of an individual license. For example, the administrator 10 may purchase 10 basic licenses, 50 standard licenses and 5 secure licenses in a single purchase. The transaction may include identification of the MDM server 138 and/or the corporation for which the purchase is being made.

In some examples, a purchase made at the operations portal 306 may need to be communicated to the license server 302. For example, the operations portion 306 may generate an activation ID associated with the purchase and provide the activation ID to the administrator 10 (e.g., via email). The administrator 10 may provide the activation ID to the license server 302 (e.g., via a communication from the MDM server 138 to the license server 302) in order to inform the license server 302 of the purchase. In other examples, a purchase made at the operations portal 306 may be automatically communicated by the operations portal 306 to the license server 302. In some examples, the license server 302 may automatically be informed of the purchase made at the operations portal 306, and the activation ID may be used by the administrator 10 to associate the MDM server 138 with the purchase.

The license server 302 may then update the license database 304 to reflect the purchase accordingly. For example, the entitlement information associated with the corresponding customer account may be updated to reflect the addition of the newly purchased licenses. Where appropriate, a new customer account for a new customer may be created in the license database 304 to store the entitlement information for the new customer.

The entitlement information stored in the license database 304 may be communicated to the MDM server 138 in order to update the MDM server 138 with up-to-date license information. This may be referred to as “activating” the licenses on the MDM server 138, although this activating of licenses is different from activation of features and devices 201 on the MDM server 138. The update may be initiated by the MDM server 138 initiating communication with the license server 302 periodically (e.g., upon trigger by a preset timer) and/or intermittently, in response to instructions from the administrator 10 and/or automatically. The license server 302 may also initiate communication with the MDM server 138 periodically and/or intermittently, after a change in the license database 304 (e.g., after a purchase of additional licenses) and/or automatically, to provide an update. Such communication between the MDM server 138 and the license server 302 may take place even if there is no update to the entitlement information.

In examples where updates occur periodically, after such an update takes place, an update timer may be reset to start a new countdown until the next update communication. In instances where the update communication is initiated by the license server 302, the MDM server 138 may assume that the license count stored on the MDM server 138 is up-to-date in the absence of an update communication from the license server 302.

In some examples, the MDM server 138 may assign licenses to individual devices 201 managed by the MDM server 138. For example, the MDM server 138 may store information about the type of license assigned to individual devices 201 and/or the license number assigned to individual devices 201. The

MDM server 138 may retain control over use and assignment of licenses. That is, no actual license, license identifier or license token may need to be communicated to individual devices 201. A license need not be locked or checked-out by a device 201 in order to use the corresponding licensed feature. Thus, the MDM server 138 may unilaterally re-assign licenses among the devices 201 and/or withdraw a license from a device 201, which may help to facilitate dynamic license management by the MDM server 138, as described further below.

In some examples, the MDM server 138 may track specifically which device 201 is assigned to use which type of license. For example, the feature usage count stored by the MDM server 138 may include information indicating the number and type of licenses assigned for each feature and/or the specific device using each type of license. For example, the feature usage count may indicate that devices no. 1-5 are individual liable devices using 5 basic licenses, devices no. 6-10 are corporate liable devices using 5 basic licenses, devices no. 11-35 are corporate liable devices using 25 standard licenses, devices no. 36-60 are third-party devices using 25 standard licenses, and devices no. 61-65 are secure devices using 5 secure licenses. This data may further include details such as the specific license number assigned to each specific device 201, the domain that each device 201 belongs to, and/or the relative priority of each device 201. Such details may be used by the MDM server 138 in the event that re-assignment of licenses is carried out, as described further below.

In some examples, the MDM server 138 may not assign licenses to specific devices 201, but may simply store the total available licenses, including the count of each type of license, and total usage of licensed features. That is, the MDM server 138 may track the total feature usage by all devices 201 and the total count of licenses, whether or not licenses are assigned to individual devices 201. For example, the feature usage count stored by the MDM server 138 may indicate that the feature usage is a total of 5 individual liable devices, 30 corporate liable devices, 25 third-party devices and 5 secure devices; and the license count may indicate there is available a total of 10 basic licenses, 50 standard licenses and 5 secure licenses.

Regardless of whether or not the MDM server 138 assigns licenses to individual devices 201, it should be understood that individual devices 201 need not be provided with licenses, license identifiers or license tokens in order to activate licensed features on the MDM server 138. Rather, the MDM server 138 may be trusted to keep accurate count of available licenses and usage of licensed features, to ensure that all usage of licensed features are sufficiently covered by the licenses held by the MDM server 138.

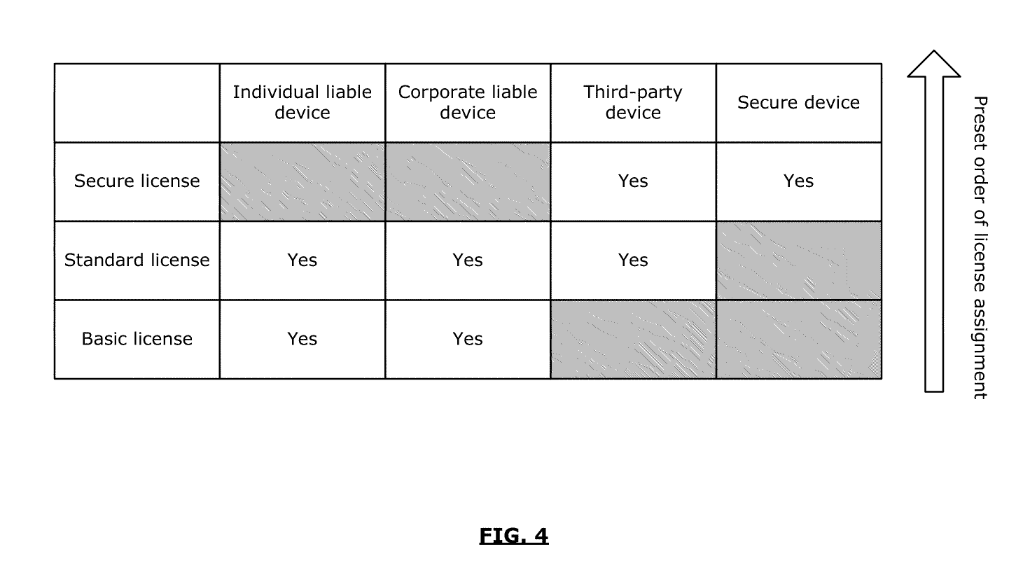

FIG. 4 is a table showing an example of different license types and the features licensed by each license type. The licenses and features shown in FIG. 4 will be referred to in various examples disclosed herein, however other license types and licensed features may be possible.

In this example, a basic license allows for activating an individual liable device or a corporate liable device on the MDM server 138; a standard license allows for activating an individual liable device, a corporate device or a third-party device on the MDM server 138; and a secure license allows for activating a third-party device or a secure device on the MDM server 138. An individual liable device may be activated using a standard license or a basic license; a corporate liable device may be activated using a standard license or a basic license; a third-party device may be activated using a secure license or a standard license; and a secure device may be activated using a secure license.

Although certain example licenses are described, other license types may be possible. For example, a simple license type may allow for activation of only an individual liable device. It should be understood that other license types and other licensed features may be managed using methods and systems of the present disclosure.

A single license may allow for activation of only a single device 201, although in some cases two or more licenses may be assigned to a single device 201 (e.g., where a single device 201 is to be activated for multiple features).

Different license types may have different purchase costs. For example, a secure license may be more expensive than a standard license, which in turn may be more expensive than a basic license. Accordingly, in order to reduce its costs, a corporation may preferentially assign a lower-cost license to a device 201, where possible (e.g., where both a basic license and a standard license are available, an individual liable device may be assigned a basic license). Such preferences may be set as a preset license reconciliation rule stored in the MDM server 138. In the example of FIG. 4, a preset license reconciliation rule may be that basic licenses are preferentially used for activation of individual liable and corporate liable devices where possible, and that standard licenses are preferentially used for activation of third-party devices where possible. Other preset license reconciliation rules may be possible, and may be preset by the administrator 10, for example.

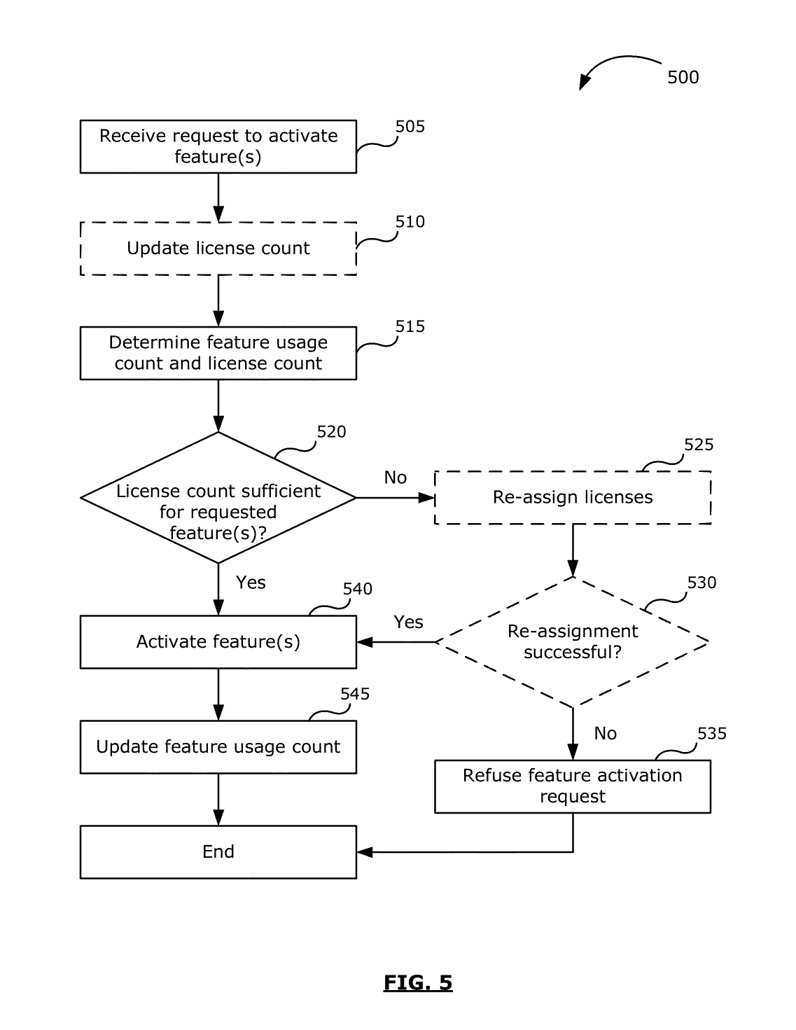

FIG. 5 is a flowchart illustrating an example method 500 for carrying out license management. The method 500 may be carried out by a server, such as the MDM server 138, managing a plurality of wireless devices 201 operating on the MDM server 138. For simplicity, the method 500 will be described as being carried out by the MDM server 138, however the method 500 may be carried out by any suitable server. The method 500 may involve the receipt and transmission of communications between the MDM server 138 and the license server 302, and may involve input and output of information between the MDM server 138 and the administrator 10. Other entities of the system 100, 300 may be involved as appropriate.

At 505, the MDM server 138 may receive a request to activate one or more features on the MDM server 138. The request may be from the administrator 10. The request may be a request for activation of certain device types on the MDM server 138. For example, the request may be a request for an additional 5 corporate liable devices to operate on the MDM server 138.

Optionally, at 510, the MDM server 138 may update the license count stored in its memory. For example, the MDM server 138 may request an update of license entitlement from the license server 302. The request for an update may be transmitted by the MDM server 138 in response to the received request to activate one or more features. In some examples, a license update may be requested only when a feature activation request is received. Updating the license information stored by the MDM server 138 in response to a received feature activation request may be referred to as “on-the-fly” or “dynamic” updating. This may help to reduce or avoid unnecessary communications between the MDM server 138 and the license server 302, while helping to ensure that the MDM server 138 will have up-to-date information on its license entitlement when such information is needed. Updating the license information stored by the MDM server 138 as part of the method 500 may help to ensure that outdated information (e.g., old license count stored in a cache memory of the MDM server 138) is updated.

In some examples, 510 may not be necessary. For example, the license count may be updated between the MDM server 138 and the license server 302 prior to the method 500. For example, there may be periodic and/or intermittent update communications between the MDM server 138 and the license server, such as described above.

At 515, the MDM server 138 may determine the feature usage count stored in its memory and the license count stored in its memory. The feature usage count may indicate the total licensed features activated on the MDM server 138, and may include a breakdown by feature. The feature usage count may not include the newly requested feature(s). The license count may indicate the total licenses held by the MDM server 138, and may include a breakdown by license types. For example, the MDM server 138 may determine from its stored data that it holds a total of 10 basic licenses, 50 standard licenses and 10 secure licenses; and that the total feature usage is 5 individual liable devices, 25 corporate liable devices, 25 third-party devices and 5 secure devices.

In examples where the MDM server 138 assigns licenses to individual devices 201, the feature usage count may include information about the type of license used by each device 201. For example, the MDM server 138 may determine from its stored data that there is a total of 10 basic licenses, 50 standard licenses and 10 secure licenses that are available; and that devices no. 1-5 are individual liable devices using basic licenses; devices no. 6-10 are corporate liable devices using basic licenses; devices no. 11-35 are corporate liable devices using standard licenses; devices no. 36-55 are third-party devices using standard licenses; and devices no. 56-60 are secure devices using secure licenses.

At 520, the MDM server 138 may determine whether the license count is sufficient to satisfy the feature activation request, in addition to the current feature usage count. This determination may also be referred to as “reconciliation” between the license count and the feature usage count.

This determination may be carried out on a bulk basis, without identifying any assignment of licenses to specific devices 201. For example, the MDM server 138 may compare the license count according to license type with the feature usage count according to feature, to determine how many licenses of each type are used up by the current feature usage and how many licenses of each type are available to accommodate the requested activation of feature(s). The MDM server 138 may use preset license reconciliation rules to determine how many licenses of each type are used up by the total feature usage.

Consider the example where, the license count indicates a total of 10 basic licenses, 50 standard licenses and 10 secure licenses are currently held by the MDM server 138; and the feature usage count indicates 5 individual liable devices, 25 corporate liable devices, 25 third-party devices and 5 secure devices are currently activated. The MDM server 138 may use the example preset license reconciliation rule shown in FIG. 4 to determine how many licenses of each type are used up. In this example, the MDM server 138 may determine that 10 basic licenses, 45 standard licenses and 5 secure licenses are used up, and that there are 5 excess standard licenses available to accommodate the requested activation of 5 corporate liable devices.

A similar determination may be carried out where the feature usage count assigns licenses to individual devices 201.

If the MDM server 138 determines that the license count is exceeded by the feature usage count or the excess license count is exceeded by the requested feature(s), the MDM server 138 may determine that the license count is insufficient to cover the requested feature(s). In the example described above, if the feature activation request is for activation of 20 corporate liable devices, the MDM server 138 may determine that the license count is insufficient to satisfy the feature activation request.

The MDM server 138 may determine that the licenses currently available are insufficient even for the current feature usage count. This may occur where previously available licenses have expired and are no longer available. This may occur even where there are sufficient licenses to satisfy the feature activation request (e.g., there may be sufficient basic licenses to allow for activation of 5 new corporate liable devices, but the secure licenses for the 5 currently activated secure devices have expired).

When the license count is determined to be insufficient, where the licenses are assigned to specific devices 201, the MDM server 138 may attempt re-assignment of licenses by proceeding to 525. Otherwise, the MDM server 138 may refuse the feature activation request at 535.

At 525, when the license count is insufficient for the requested feature(s), the MDM server 138 may attempt to re-assign licenses, in order to comply with the license count and allow the requested feature(s). This may be carried out where the feature usage count includes device-specific license assignment information, and may not be carried out where the feature usage count does not include device-specific information. Re-assignment may be carried out based on one or more re-assignment rules such as preset license reconciliation rule(s) (e.g., as illustrated in FIG. 4), device priority (e.g., corporate liable devices may be prioritized over individual liable devices), time of feature activation (e.g., earlier activated features may be prioritized over later activated features) and/or any other suitable rules.

In some examples, one or more devices 201 may be flagged (e.g., by an administrator 10) as having higher priority than others. License reconciliation rules may designate that such higher priority devices should be assigned licenses preferentially over lower priority devices. This may mean that, in the event license count is insufficient to cover feature usage count, licenses may be re-assigned from a lower priority device to a higher priority device, leaving the lower priority device without a license.

If license re-assignment results in a device 201 being without a license for a particular feature, the MDM server 138 may take appropriate action, such as preventing the device 201 from accessing the particular feature. The device 201 that lost the license may be flagged as having lost the license, so that appropriate action may be taken.

An example of re-assignment is now described. Consider a feature activation request for an addition of 5 corporate liable devices. The MDM server 138 may determine that there is a total of 10 basic licenses, 50 standard licenses and 10 secure licenses that are available; and that devices no. 1-5 are individual liable devices using basic licenses; devices no. 6-10 are corporate liable devices using basic licenses; devices no. 11-35 are corporate liable devices using standard licenses; devices no. 36-60 are third-party devices using standard licenses; and devices no. 61-65 are secure devices using secure licenses. In this case, all 10 basic licenses and all 50 standard licenses are already assigned for use by currently activated devices 201. The MDM server 138 may attempt re-assignment of licenses, in order to accommodate the feature activation request. Based on preset license reconciliation rules (e.g., as shown in FIG. 4), the MDM server 138 may determine that devices no. 56-60, which are third-party devices, should be re-assigned to use secure licenses, thus freeing up 5 standard licenses to allow for the requested activation of 5 new corporate liable devices. On the other hand, if there are only 5 secure licenses available, which are all already used by 5 secure devices, the re-assignment attempt may fail.

In some examples, re-assignment of licenses may also be carried out even if, at 520, it was determined that the license count is sufficient to accommodate the feature activation request. The MDM server 138 may re-assign licenses in order to comply with preset license reconciliation rules (e.g., as shown in FIG. 4) regardless of the sufficiency of the license count. For example, where the MDM server 138 determines that there are 10 basic licenses available and only 5 basic licenses have been assigned, the MDM server 138 may attempt to re-assign the 5 unused basic licenses to any individual liable or corporate liable devices currently assigned to standard licenses.

Re-assignment of licenses may be automatically initiated and carried out by the MDM server 138, without requiring explicit instructions or interaction from the administrator 10. Such re-assignment may take place dynamically when attempting activation of newly requested feature(s). Carrying out re-assignment dynamically in response to a feature activation request, rather than periodically, may help to ensure that desired features are accommodated as much as possible by currently held licenses while avoiding use of processing resources in determining and re-assigning license usage when not necessary.

At 530, if the re-assignment successfully reconciles the license count with feature usage count and makes available sufficient free licenses to accommodate the feature activation request, the requested feature(s) may be activated at 540. Otherwise, the MDM serve 138 may refuse the feature activation request at 535.

If the feature activation request is refused at 535, the MDM server 138 may provide output to the administrator 10 indicating refusal of the requested features. The output may indicate a reason for the refusal and may include information indicating the current license count and current feature usage. The output may include a recommendation to acquire the necessary license(s). For example, the MDM server 138 may automatically generate output to the administrator 10 providing a recommendation to purchase additional licenses and may include a recommendation of the number and/or type of licenses to purchase (e.g., based on a preset license reconciliation rule).

If the license count is sufficient for the requested feature(s) or if re-assignment is successful, then at 540 the requested feature(s) is(are) activated on the MDM server 138. This may include creation of new device accounts on the MDM server 138, which may be carried out using various suitable methods.

The MDM server 138 may provide output to the administrator 10 confirming that the requested feature(s) has(have) been activated. The output may include details about the feature usage count and/or license count. Where licenses are assigned to specific devices 201, the output may include information of the specific license(s) and/or license type(s) assigned to the requested feature(s).

In some examples, if the licenses available are sufficient to satisfy only a portion of the requested feature(s), the MDM server 138 may allow activation of requested feature(s) to the extent allowable by the available licenses. The MDM server 138 may provide output to the administrator 10 with information about the portion of requested feature(s) activated and the portion not activated.

At 545, the MDM server 138 may update its stored data by updating the feature usage count to include the newly activated feature(s). Although described after 540, 545 may be carried out earlier, for example the MDM server 138 may update the feature usage count any time after the license count is determined to be sufficient or any time after successful re-assignment.

The method 500 may then end.

One or more inputs and/or outputs of the method 500 may be received from and/or provided to the administrator 10 through an administrative interface, such as the web portal 306. For example, an administrative dashboard interface may provide information about the license count available and the feature usage count for the MDM server 138, and may provide the administrator 10 with output indicating the success or failure of feature activation.

Variations on the example method 500 may be possible, in accordance with various suitable license management techniques.

For example, overdraft of licenses may be permissible. Overdraft may allow the feature usage count to exceed the license count, up to a predefined overdraft amount. The permissible overdraft may be defined in the license database 304 for different customer accounts, and may differ among different license types and/or among different customer accounts, for example. The permissible overdraft may be included in the license count communicated from the license server 302 to the MDM server 138, such that the license count stored by the MDM server 138 actually is a total of the available licenses plus permissible overdraft; or may be communicated as a separate overdraft license count such that the MDM server 138 stores an overdraft license count in addition to the license count. The overdraft may be used to accommodate the feature activation request.

In some examples, the overdraft may be associated with a time period (which may also be referred to as “grace period”), such that overdraft (e.g., up to a certain defined overdraft amount, or without limit) may be permissible only for a predefined time period (e.g., 10 days). During the overdraft time period, use of a licensed feature without the associated license may be permissible. Once the overdraft time period expires, use of the licensed feature may no longer be permissible. For example, a customer may own 5 basic licenses that have overdraft time periods of 10 days. The customer may activate 5 individual liable devices on its MDM server 138 using the 5 basic licenses. The customer may be able to activate a 6th individual liable device without purchasing a 6th basic license, but only for the duration of the overdraft time period. When the 6th device is activated, the overdraft time period may be initiated (e.g., may be tracked by a timer at the MDM server 138). When the overdraft time period expires (e.g., the timer at the MDM server 138 expires), if the 6th basic license is not yet purchased, operation of the 6th device on the MDM server 138 may be disabled. Where the overdraft time period is tracked by the MDM server 138 using a timer, the timer may be maintained by asynchronous processes, which may also intermittently reconcile feature usage count with license count.

In some examples, enforcement actions may be taken by the MDM server 138 and/or the license server 302 in the event that the license count is insufficient to cover the current feature usage count and/or the requested new features(s), or in the event that a customer account enters or exceeds the permissible overdraft. Enforcement actions may include, for example, billing interest or penalties to the customer account, disabling of one or more current license entitlements and/or features, and/or denial of new license purchases.

The licenses may relate to features provided directly by the MDM server 138, the wireless connector system 120 or some other third-party. Features provided by the wireless connector system 120 may be provided to devices 201 via the MDM server 138. Features provided by a third-party may be provided to devices 201 via the MDM server 138 or directly by the third-party. If features are provided directly by the third-party, the MDM server 138 may serve to manage the third-party licenses and to inform the third-party what features should be activated.

The MDM server 138 may also provide license management services to a third-party that is requesting activation of licensed features. Thus, the MDM server 138 may act as an intermediary between the third-party and the license server 302, and may take on the burden of license management and communications with the license server 302 on behalf of the third-party.

Licenses may be generated by the license server 302 and/or may be provided to the license server 302 by an entity external to the license server 302.

The present disclosure may provide methods and systems for managing licenses for feature entitlement and/or allocation for wireless devices. The present disclosure may allow for management of licenses across devices belonging to different domains, and may include management of third-party licenses.

The present disclosure may allow for on-the-fly, dynamic determination of license usage and/or license re-assignment, in response to a request for activation of feature(s). By managing licenses dynamically in this manner (rather than performing a periodic update of license usage), the present disclosure may allow activation of licensed features based on up-to-date license information without wasting processing resources on unnecessary license management tasks.

The present disclosure may help ensure that control of licenses is maintained by the MDM server 138 at all times, so that licenses are not unnecessarily locked or used up by devices 201 that are not currently using the corresponding licensed feature. The present disclosure may also allow the MDM server 138 to better manage allocation of licenses, such as according to feature priority and/or device priority. Although the disclosure describes assignment of licenses to devices 201 by the MDM server 138, it should be understood that such assignment does not result in ownership or locking down of the licenses by the respective assigned devices 201.

The present disclosure may simplify license management by allowing the MDM server 138 to manage licenses in bulk (that is, without having to identify licenses as being held by individual devices 201). This may remove the need to store information about specific license assignments. Instead, licenses may be managed by reconciling total license count and total feature usage count.

Although described with respect to the MDM server 138, the present disclosure may enable license and feature usage reconciliation by any server, since the server itself need not store specific license information. For example, any server having access to a database about device configurations and having access to the license server 302 may carry out license reconciliation. This may reduce or eliminate any impact to license usage in the event a server is lost. This may be useful where devices 201 are managed by a group of distributed servers (e.g., where the MDM server 138 in fact includes more than one server), for example.

The present disclosure describes the activation of devices on a server as an example of licensed features that may be activated on the server. This disclosure may be applicable to other features, including features of the MDM server 138 that may not relate to devices 201 managed by the MDM server 138. For example, administrative features may be licensed for use by the MDM server 138. The activation of such administrative features on the MDM server 138 and the reconciliation with corresponding licenses may be carried out in accordance with the present disclosure.

Although the present disclosure describes methods and processes with steps in a certain order, one or more steps of the methods and processes may be omitted or altered as appropriate. One or more steps may take place in an order other than that in which they are described, as appropriate.

While the present disclosure is described, at least in part, in terms of methods, a person of ordinary skill in the art will understand that the present disclosure is also directed to the various components for performing at least some of the aspects and features of the described methods, be it by way of hardware components, software or any combination of the two, or in any other manner. Moreover, the present disclosure is also directed to a pre-recorded storage device or other similar non-transient computer readable medium including program instructions stored thereon for performing the methods described herein, including DVDs, CDs, volatile or non-volatile memories, or other storage media, for example.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, while the systems, devices and processes disclosed and shown herein may comprise a specific number of elements/components, the systems, devices and assemblies could be modified to include additional or fewer of such elements/components. For example, while any of the elements/components disclosed may be referenced as being singular, the embodiments disclosed herein could be modified to include a plurality of such elements/components. The subject matter described herein intends to cover and embrace all suitable changes in technology. All references mentioned are hereby incorporated by reference in their entirety.

1. A method for management of licenses for licensed features activatable on a server, the method comprising:
in response to receipt of a request for activation of a requested feature on the server, determining a license count and a feature usage count, the license count being indicative of a count of all licenses activated on the server, and the feature usage count being indicative of all licensed features activated on the server;
determining whether the license count is sufficient to satisfy the request;
when the license count is sufficient to cover the request, allowing activation of the requested feature on the server; and
otherwise, refusing the request.

2. The method of claim 1, wherein the license count comprises a count of all licenses according to license type and the feature usage count comprises a count of all licensed features according to feature type.

3. The method of claim 1, wherein the licensed feature comprises a feature used by wireless devices operating on the server.

4. The method of claim 3, wherein the feature usage count comprises an assignment of license type or license identifier to individual wireless devices operating on the server.

5. The method of claim 4, wherein determining whether the license count is sufficient comprises attempting a re-assignment of licenses to individual wireless devices according to one or more re-assignment rules.

6. The method of claim 1, wherein determining the license count comprises requesting an update from a license server.

7. The method of claim 1, wherein the licensed features comprise activation of a wireless device for operation on the server.

8. The method of claim 1, wherein determining whether the license count is sufficient is based on one or more preset license reconciliation rules.

9. A server for management of licenses for licensed features activatable on the server, the server comprising a processor configured to execute computer-readable instructions executable to cause the server to:
in response to receipt of a request for activation of a requested feature on the server, determine a license count and a feature usage count, the license count being indicative of a count of all licenses activated on the server, and the feature usage count being indicative of all licensed features activated on the server;
determine whether the license count is sufficient to satisfy the request;
when the license count is sufficient to cover the request, allow activation of the requested feature on the server; and
otherwise, refuse the request.

10. The server of claim 9, wherein the license count comprises a count of all licenses according to license type and the feature usage count comprises a count of all licensed features according to feature type.

11. The server of claim 9, wherein the licensed feature comprises a feature used by wireless devices operating on the server.

12. The server of claim 11, wherein the feature usage count comprises an assignment of license type or license identifier to individual wireless devices operating on the server.

13. The server of claim 12, wherein the instructions further cause the server to determine whether the license count is sufficient including attempting a re-assignment of licenses to individual wireless devices according to one or more re-assignment rules.

14. The server of claim 9, wherein the instructions further cause the server to determine the license count including requesting an update from a license server.

15. The server of claim 9, wherein the licensed features comprise activation of a wireless device for operation on the server.

16. The server of claim 9, wherein the instructions further cause the server to determine whether the license count is sufficient based on one or more preset license reconciliation rules.

17. A computer program product tangibly embodying computer-readable instructions thereon, the instructions being executable to cause a processor to:
in response to receipt of a request for activation of a requested feature on a server, determine a license count and a feature usage count, the license count being indicative of a count of all licenses activated on the server, and the feature usage count being indicative of all licensed features activated on the server;
determine whether the license count is sufficient to satisfy the request;
when the license count is sufficient to cover the request, allow activation of the requested feature on the server; and
otherwise, refuse the request.

18. The computer program product of claim 17, wherein the license count comprises a count of all licenses according to license type and the feature usage count comprises a count of all licensed features according to feature type.

19. The computer program product of claim 17, wherein the licensed feature comprises a feature used by wireless devices operating on the server and the feature usage count comprises an assignment of license type or license identifier to individual wireless devices operating on the server.

20. The computer program product of claim 17, wherein the licensed features comprise activation of a wireless device for operation on the server.

21. The method of claim 1, further comprising updating the licensed features activatable on the server in response to receipt of an update communication.
